(19) United States
(12) Patent Application Publication
(10) Pub. No.: US 2014/0268466 A1
(43) Pub. Date: Sep. 18, 2014

(54) POWER PROTECTION CIRCUIT

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/202,038

(22) Filed: Mar. 10, 2014

(30) Foreign Application Priority Data
Mar. 18, 2013 (CN) 2013100849682

(51) Int. Cl. H02H 5/04

(52) U.S. Cl. CPC H02H 5/047
USPC 361/106

(57) ABSTRACT

A power protection circuit includes a power source, a first voltage division module, a second voltage division module, a comparison module, an electronic switch, and a power module. The first voltage division module divides a voltage from the power source and outputs a first voltage. The second voltage division module divides the voltage from the power source and outputs a second voltage. The second voltage has a negative temperature coefficient. A temperature of the second voltage division module increases when a temperature of the power module increases. The comparison module is used to compare the first voltage to the second voltage and output first or second signals corresponding to the comparing result. The electronic switch is turned on or off when the electronic switch receives the first or second signals from the comparison module.

### BACKGROUND

1. Technical Field

The present disclosure relates to a power protection circuit.

2. Description of Related Art

A power module on a motherboard supplies power to electronic components of the motherboard. When the power module operates abnormally, the power module could output high current, which could cause the temperature of the motherboard to increase. If the power module cannot be shut down in time, the motherboard could be damaged.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a power protection circuit of the present disclosure.

FIG. 2 is a circuit diagram of an embodiment of the power protection circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The reference “a plurality of” means “at least two.”

FIGS. 1 and 2 show an embodiment of a power protection circuit 10 of the present disclosure. In one embodiment, the power protection circuit 10 is used to protect a power module 60 from overheating.

In one embodiment, the power protection circuit 10 comprises a power source 20, a first voltage division module 31, a second voltage division module 32, a comparison module 40, and an electronic switch 50.

Referring to FIG. 2, in one embodiment, the first voltage division module 31 comprises a first resistor R1 and a second resistor R2. The power source 20 comprises a first power input terminal Vcc1. The first power input terminal Vcc1 is grounded through the first resistor R1 and the second resistor R2 in that order. The second voltage division module 32 comprises a third resistor R3 and a fourth resistor R4. The first power input terminal Vcc1 is grounded through the third resistor R3 and the fourth resistor R4 in that order.

The comparison module 40 comprises an operational amplifier U1. A non-inverting input of the operational amplifier U1 is electrically connected to a node between the first resistor R1 and the second resistor R2. An inverting input of the operational amplifier U1 is electrically connected to a node between the third resistor R3 and the fourth resistor R4.

In the embodiment, the electronic switch 50 is an n-channel metal-oxide semiconductor field-effect transistor (MOSFET) Q1. A gate of the MOSFET Q1 is electrically connected to an output of the operational amplifier U1. A source of the MOSFET Q1 is grounded.

The power module 60 comprises a control chip 70, fifth to seventh resistors R5-R7, MOSFETs Q2-Q3, first to fifth capacitors C1-C5, a first inductor L1, a second inductor L2, a second power input Vin, and a first power output Vout. The control chip 70 comprises eight pins. A first signal pin HGATE of the control chip 70 is electrically connected to a gate of the MOSFET Q2. A drain of the MOSFET Q2 is electrically connected to the second power input terminal Vin through the first inductor L1. A source of the MOSFET Q2 is electrically connected to a second signal pin PHASE of the control chip 70. The source of the MOSFET Q2 is also electrically connected to a drain of the MOSFET Q3. A gate of the MOSFET Q3 is electrically connected to a third signal pin LGATE of the control chip 70. A source of the MOSFET Q3 is grounded. A boot pin Boot of the control chip 70 is electrically connected to a drain of the MOSFET Q1. The boot pin Boot of the control chip 70 is also electrically connected to the second signal pin PHASE of the control chip 70 through the fifth resistor R5 and the first capacitor C1 in that order. A drain of the MOSFET Q2 is grounded through the second capacitor C2. The third capacitor C3 and the second capacitor C2 are connected in parallel. The second signal pin PHASE is grounded through the second inductor L2, the sixth resistor R6, and the seventh resistor R7 in that order. A node between the second inductor L2 and the sixth resistor R6 is electrically connected to the first power output terminal Vout. The first power output terminal Vout is grounded through the fourth capacitor C4. The fifth capacitor C5 and the fourth capacitor C4 are connected in parallel. A node between the sixth resistor R6 and the seventh resistor R7 is electrically connected to a feedback pin FB of the control chip 70. When the control chip 70 operates normally, the control chip 70 outputs a high-level signal, such as logic 1, through the boot pin Boot.

In the embodiment, a resistance of the first resistor R1 is substantially equal to a resistance of the third resistor R3. A resistance of the second resistor R2 is smaller than a resistance of the fourth resistor R4. The fourth resistor R4 is a negative temperature coefficient thermistor. The fourth resistor R4 is used to sense a temperature of the power module 60. In the embodiment, the fourth resistor R4 is arranged sufficiently close to the control chip 70, such that a temperature of the fourth resistor R4 increases when a temperature of the control chip 70 increases. When the temperature of the control chip 70 is not higher than a first preset temperature, the temperature of the fourth resistor R4 is not higher than a second preset temperature, the resistance of the fourth resistor R4 is not less than the resistance of the second resistor R2, a voltage of the non-inverting input of the operational amplifier U1 is not higher than a voltage of the inverting input of the operational amplifier U1, and the operational amplifier U1 outputs a low-level signal, such as logic 0, to the gate of the MOSFET Q1. As a result, the drain of the MOSFET Q1 is disconnected from the source of the MOSFET Q1, the first signal pin HGATE is driven by the boot pin Boot, the first signal HGATE is at a high level, and the MOSFET Q2 is turned on. Thus, the drain of the MOSFET Q2 is electrically connected to the source of the MOSFET Q2, and the second power input terminal Vin is electrically connected to the first power output terminal Vout.

When the temperature of the control chip 70 is higher than the first preset temperature, the fourth resistor R4 is higher than the second preset temperature. The resistance of the resistor R4 is less than the resistance of the second resistor R2, the voltage of the non-inverting input of the operational amplifier U1 is higher than the voltage of the inverting input of the operational amplifier U1, and the operational amplifier U1 outputs a high-level signal to the gate of the MOSFET Q1, which turns on the MOSFET Q1. When the MOSFET Q1 is turned on, the boot pin Boot of the operational amplifier U1 is grounded, the first signal pin HGATE of the operational amplifier U1 is at a low-level, the MOSFET Q2 is turned off, and the first power output terminal Vout is disconnected from the second power input terminal Vin. Thus, the power module 60 stops operating.

The power protection circuit 10 turns off the power module 60 when the temperature of the power module 60 is greater than the first preset temperature, thus preventing damage to the motherboard.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power protection circuit, comprising:
a power source;
a first voltage division module electrically connected to the power source to divide a voltage input by the power source and output a first voltage;
a second voltage division module electrically connected to the power source to divide the voltage input by the power source and output a second voltage, wherein the second voltage has a negative temperature coefficient;
a comparison module electrically connected to the first and second voltage division modules to receive the first and second voltages, wherein the comparison module compares the first voltage to the second voltage, when the first voltage is not less than the second voltage, the comparison module outputs a first signal, when the first voltage is less than the second voltage, the comparison module outputs a second signal;
an electronic switch electrically connected to the comparison module, wherein the electronic switch is turned on when the electronic switch receives the first signal from the comparison module, the electronic switch is turned off when the electronic switch receives the second signal from the comparison module; and
a power module providing power to a motherboard, wherein a boot pin of the power module is electrically connected to the electronic switch, the second voltage division module is arranged close to the power module, a temperature of the second voltage division increases when a temperature of the power module increases, when the electronic switch is turned on, the power module stops providing power to the motherboard, and when the electronic switch is turned off, the power module provides power to the motherboard.

2. The power protection circuit of claim 1, wherein the first voltage division module comprises a first resistor and a second resistor, the power source is grounded through the first resistor and second resistor in that order, the second voltage division module comprises a third resistor and a fourth resistor, and the power source is grounded through the third resistor and the fourth resistor in that order.

3. The power protection circuit of claim 2, wherein the comparison module comprises an operational amplifier, a non-inverting input of the operational amplifier is electrically connected to a node between the first resistor and the second resistor, and an inverting input of the operational amplifier is electrically connected to a node between the third resistor and the fourth resistor.

4. The power protection circuit of claim 3, wherein the electronic switch is an n-channel metal-oxide-semiconductor field effect transistor (MOSFET), a gate of the MOSFET is electrically connected to an output of the operational amplifier, a source of the MOSFET is grounded, and a drain of the MOSFET is electrically connected to the power module.

5. The power protection circuit of claim 4, wherein the power module comprises a control chip, fifth to seventh resistors, first and second MOSFETs, first to fifth capacitors, first and second inductors, a power input terminal, and a power output terminal, a first signal pin of the control chip is electrically connected to a gate of the first MOSFET, the power input terminal is electrically connected to a drain of the first MOSFET through the first inductor, a source of the first MOSFET is electrically connected to the second signal pin of the control chip and a drain of the second MOSFET, a gate of the second MOSFET is electrically connected to a third signal pin of the control chip, a source of the second MOSFET is grounded, a boot pin of the control chip is electrically connected to the drain of the electronic switch, the boot pin is electrically connected to the second signal pin of the control chip through the fifth resistor and the first capacitor in that order, the drain of the first MOSFET is grounded through the second capacitor, the second and third capacitors are connected in parallel, the second signal pin of the control chip is grounded through the second inductor, the sixth resistor and the seventh resistor in that order, the power output terminal is electrically connected to a node between the second inductor and the sixth resistor, the power output terminal is grounded through the fourth capacitor, the fourth and fifth capacitors are connected in parallel, and a feedback pin of the control chip is electrically connected to a node between the sixth resistor and the seventh resistor.

6. The power protection circuit of claim 5, wherein the fourth resistor is a negative temperature coefficient thermistor and senses the temperature of the control chip.
